(19) United States
(12) Patent Application Publication
(10) Pub. No.: US 2026/0222294 A1
(43) Pub. Date: Jul. 30, 2026

(54) DETERMINING CONFIGURATION CHANGE IMPACTS ON DATA CENTER DEVICES USING MACHINE LEARNING TECHNIQUES

(71) Applicant: Dell Products L.P., Round Rock, TX (US)

(72) Inventors: Parminder Singh Sethi, Punjab (IN); Vasanth Sathyanarayanan, Bangalore (IN); Praveen Kumar, Noida (IN)

(73) Assignee: Dell Products L.P., Round Rocks, TX (US)

(21) Appl. No.: 19/038,104

(22) Filed: Jan. 27, 2025

(51) Int. Cl. H04L 41/08; H04L 41/16

(52) U.S. Cl. CPC H04L 41/0886; H04L 41/16

(57) ABSTRACT

Methods, apparatus, and processor-readable storage media for determining configuration change impacts on data center devices using machine learning techniques are provided herein. An example computer-implemented method includes obtaining information pertaining to proposed configuration changes to a first set of devices within at least one data center; predicting a second set of devices, within the data center(s), which will be impacted in connection with the proposed configuration changes by processing the obtained information using machine learning techniques; processing the obtained information and the predicted second set of devices using at least one consensus mechanism associated with at least one blockchain; determining, using one or more smart contracts associated with the blockchain(s), whether to add at least one new block to the blockchain(s) in response to the processing using the consensus mechanism(s); and performing automated actions based on the determining of whether to add at least one new block to the blockchain(s).

### BACKGROUND

Data centers can grow quickly due to Internet of Things (IoT) devices, cloud solutions, digital transformations, etc. Also, changes within a data center can result in unforeseen and/or unexpected impacts and/or issues across one or more devices, and the growth of data centers can exacerbate such problems. However, conventional data center management approaches typically include resource-intensive methods for investigating change impacts that are often reactive in nature and prone to mistakes, potentially leading to downtimes and disruptions.

### SUMMARY

Illustrative embodiments of the disclosure provide techniques for determining configuration change impacts on data center devices using machine learning techniques.

An example computer-implemented method includes obtaining information pertaining to one or more proposed configuration changes to a first set of one or more devices within at least one data center, and predicting a second set of one or more devices, within the at least one data center, which will be impacted in connection with at least a portion of the one or more proposed configuration changes by processing the obtained information using one or more machine learning techniques. The method also includes processing the obtained information and the predicted second set of one or more devices which will be impacted using at least one consensus mechanism associated with at least one blockchain, and determining, using one or more smart contracts associated with the at least one blockchain, whether to add at least one new block to the at least one blockchain in response to the processing of the obtained information and the predicted second set of one or more devices which will be impacted using the at least one consensus mechanism. Further, the method additionally includes performing one or more automated actions based at least in part on the determining of whether to add at least one new block to the at least one blockchain.

Illustrative embodiments can provide significant advantages relative to conventional data center management approaches. For example, problems associated with resource-intensive methods that are often reactive in nature and prone to mistakes are overcome in one or more embodiments through predicting impacts on data center devices in connection with proposed device configuration changes using machine learning techniques and blockchain technology.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for determining configuration change impacts on data center devices using machine learning techniques in an illustrative embodiment.

FIG. 2 shows an example dataset of historical impact data in an illustrative embodiment.

FIG. 3 shows an example workflow in an illustrative embodiment.

FIG. 4 is a flow diagram of a process for determining configuration change impacts on data center devices using machine learning techniques in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

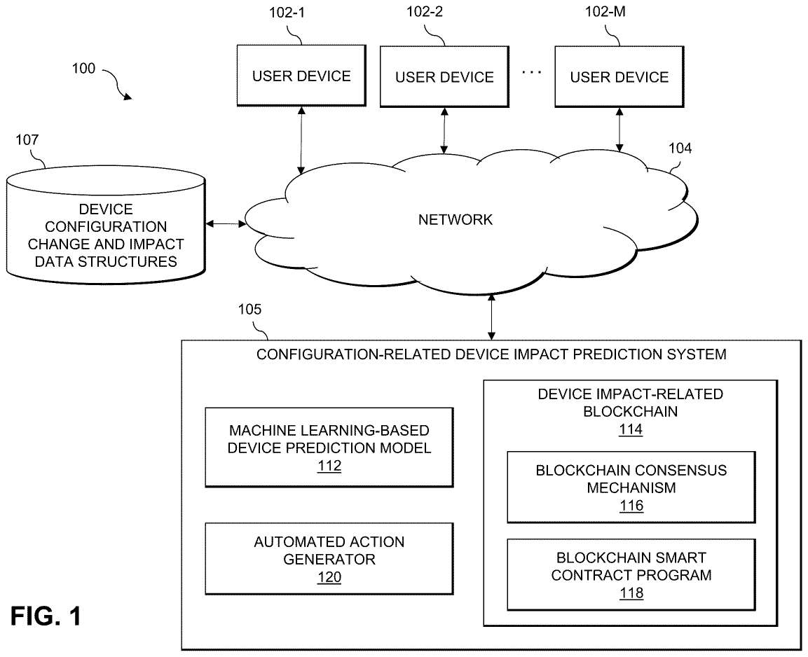

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is configuration-related device impact prediction system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the configuration-related device impact prediction system 105 can have one or more device configuration change and impact data structures 107 configured to store data pertaining to historical configuration changes made to data center devices, historical impact data attributed to data center devices related to device configuration changes, device identifying data, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The device configuration change and impact data structures 107 in the present embodiment are implemented using one or more storage systems associated with the configuration-related device impact prediction system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the configuration-related device impact prediction system 105 are one or more input-output devices, which illustratively comprise keyboards, displays or other types of input-output devices in any combination. Such input-output devices can be used, for example, to support one or more user interfaces to the configuration-related device impact prediction system 105, as well as to support communication between the configuration-related device impact prediction system 105 and other related systems and devices not explicitly shown.

Additionally, the configuration-related device impact prediction system 105 in the FIG. 1 embodiment is assumed to be implemented using at least one processing device. Each such processing device generally comprises at least one processor and an associated memory, and implements one or more functional modules for controlling certain features of the configuration-related device impact prediction system 105.

More particularly, the configuration-related device impact prediction system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the configuration-related device impact prediction system 105 to communicate over the network 104 with the user devices 102, and illustratively comprises one or more conventional transceivers.

The configuration-related device impact prediction system 105 further comprises a machine learning-based device prediction model 112, a device impact-related blockchain 114, which includes blockchain consensus mechanism 116 and blockchain smart contract program 118, and automated action generator 120.

In at least one embodiment, the machine learning-based device prediction model 112 can be implemented to predict a set of one or more devices, within at least one data center, which will be impacted in connection with at least a portion of one or more proposed data center device configuration changes by processing related information using one or more machine learning techniques. Also, in such an embodiment, the blockchain consensus mechanism 116 can be implemented to process the related information and the predicted set of one or more devices which will be impacted, and the blockchain smart contract program 118 can be implemented to determine whether to add at least one new block to the device impact-related blockchain 114 in response to the processing by the blockchain consensus mechanism 116. Further, in such an embodiment, the automated action generator 120 can be implemented to perform one or more automated actions based at least in part on the determining of whether to add at least one new block to the device impact-related blockchain 114.

It is to be appreciated that this particular arrangement of elements 112, 114, 116, 118 and 120 illustrated in the configuration-related device impact prediction system 105 of the FIG. 1 embodiment is presented by way of example only, and alternative arrangements can be used in other embodiments. For example, the functionality associated with elements 112, 114, 116, 118 and 120 in other embodiments can be combined into a single module, or separated across a larger number of modules. As another example, multiple distinct processors can be used to implement different ones of elements 112, 114, 116, 118 and 120 or portions thereof.

At least portions of elements 112, 114, 116, 118 and 120 may be implemented at least in part in the form of software that is stored in memory and executed by a processor.

It is to be understood that the particular set of elements shown in FIG. 1 for determining configuration change impacts on data center devices using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of configuration-related device impact prediction system 105, device configuration change and impact data structures 107, and user devices can be on and/or part of the same processing platform.

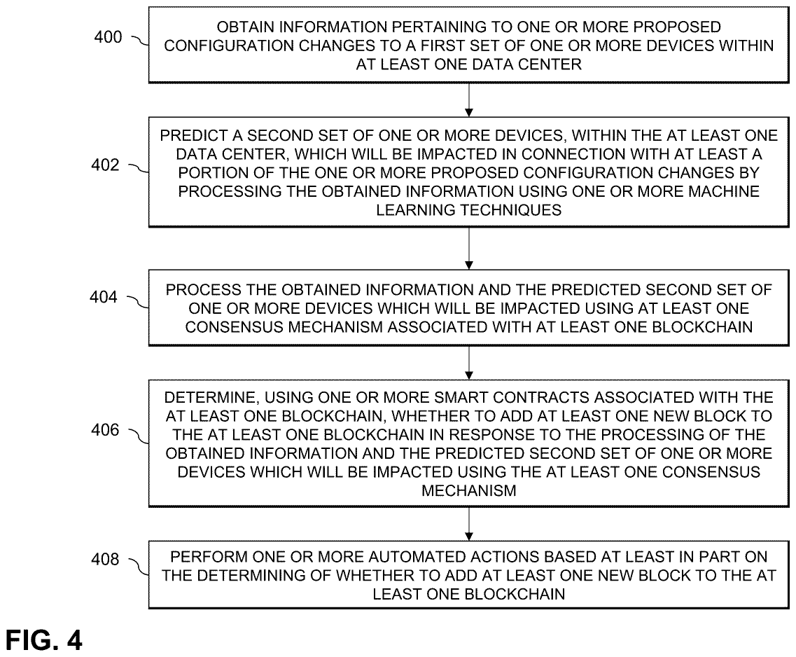

An example process utilizing elements 112, 114, 116, 118 and 120 of an example configuration-related device impact prediction system 105 in computer network 100 will be described in more detail with reference to the flow diagram of FIG. 4.

Accordingly, at least one embodiment includes determining configuration change impacts on one or more devices and/or one or more services in a given data center using at least one random forest model and at least one blockchain. Such an embodiment can also include predicting and/or assessing the impact of configuration changes (e.g., planned changes) on the overall data center. As detailed herein, configuration changes at a data center device level can bring impact to one or more other devices in the data center. For example, if the throughput of a first device decreases because of configuration changes, then at least one other device which is expecting data from the first device would also experience a cascading impact. Accordingly, at least one embodiment includes implementing an automated solution that enables administrators to identify and/or visualize the impact of changes to improve efficiency, reduce downtime, and avoid unexpected problems with respect to data center operations.

In one or more embodiments, the at least one blockchain implemented includes at least one permissioned blockchain, wherein the at least one blockchain is restricted with access limited to the authorized stakeholders. Additionally or alternatively, such a blockchain can include at least one access control layer which provides a layer of security to limit access to the blockchain to users and/or devices with one or more requisite permissions.

Also, in at least one embodiment, various combinations of configuration data for various data center devices, and subsequent performance and/or operational data for various data center devices, can be used for training one or more random forest models. Accordingly, in such an embodiment, the one or more random forest models include at least one machine learning algorithm that uses a collection of decision trees to generate predictions pertaining to one or more device impacts resulting from device configuration changes. Each such decision tree includes a flow diagram that utilizes one or more conditions to predict one or more designated outcomes, and each such decision tree can be trained with a designated amount of random noise. Additionally, in such an embodiment, the one or more random forest models encompass ensemble learning techniques, wherein the one or more models combine the output of multiple decision trees (e.g., all of the decision trees in the one or more models) to generate and/or reach a single prediction. Further, in such an embodiment, the decision trees can each be distinct and/or different from each other, facilitating the determining and/or learning of unique patterns in the corresponding data. Also, the training data used for each decision tree in such an embodiment can be drawn, for example, using bootstrap sampling with replacement.

By way of illustration, consider an example use case which involves a data center comprising 8,000 devices across multiple floors of a building, wherein each floor specializes in different services as follows: a first floor for web hosting, a second floor for user support systems, and a third floor for data analytics. Configuration changes by a first floor administrator could inadvertently affect devices used for data analytics on the third floor, risking service disruptions. Conventional approaches lack methods to identify affected devices, which complicates decision-making for administrators. However, in accordance with one or more embodiments, improved identification of impacted devices enables more efficient configuration changes and/or proactive measures to prevent downtime.

At least one embodiment includes generating at least one dependency tree of the devices within a data center. Given one or more proposed configuration changes to one of the devices, historical device configuration changes and corresponding impact data is collected and/or obtained. Based at least in part on processing at least a portion of such historical data, at least one machine learning model predicts one or more impacted devices within the data center. Identifying information of the one or more predicted impacted device is then generated and output to one or more users and/or one or more separate systems. A consensus mechanism is then used in connection with at least one blockchain to validate the proposed change and predicted impact(s), and a new block is added to the at least one blockchain if consensus is reached.

Accordingly, one or more embodiments include storing information pertaining to configuration changes made to devices in at least one data structure (e.g., device configuration change and impact data structures 107 depicted in FIG. 1). For example, when an administrator wants to make a configuration change to a device, at least one machine learning model is used to predict the impact of this change on one or more other devices, based at least in part on relevant historical data. A list of predicted impacted devices can then be generated and shared with stakeholders for consensus in a corresponding blockchain. In at least one embodiment, the blockchain utilizes a multi-signature consensus mechanism to gather consensus from all stakeholders. If consensus is received from all stakeholders (that is, all stakeholders agree that the given transaction should be added to the blockchain), a smart contract in the blockchain automatically adds a block for the configuration change. However, if consensus is not received, a new block is not added, and the configuration change is rejected. Further, at least a portion of the configuration change and impact data is ingested back into the at least one data structure for additional and/or continuous training. Also, in one or more embodiments, the signatures used in such a multi-signature consensus mechanism can include, for example, cryptographically-secure digital signatures.

As noted herein, one or more embodiments include creating at least one device dependency tree. In such an embodiment, a thin client referred to as the dependency tracker software layer is deployed across all devices within a data center. This client regularly checks connectivity between devices in the data center by polling the devices. By way of example, the (adjustable) polling interval can be set, e.g., to ten minutes, following the existing setup. After each polling cycle, the system retrieves port-to-port connectivity details for at least a portion of the connected devices (e.g., all connected devices). Subsequently, one or more embodiments can include constructing and/or updating a device dependency tree, storing this information within each device's data store. The device dependency tree can undergo automatic updates following each polling event whenever there are changes in device connectivity and/or when one or more new devices are introduced into the data center.

In constructing a dependency tree, at least one embodiment can include implementing logic that includes determining the port connectivity of each device in the data center with other directly connected devices, and gathering connectivity data for all devices in the data center. Such logic also includes analyzing the collected information to identify directly and indirectly connected devices for each device. Additionally, such logic includes constructing a dependency tree for each device using the identified connectivity information, and storing the constructed dependency tree in a local data store of the respective device.

Additionally, one or more embodiments include using at least one random forest model to predict the impact(s) of device configuration changes across other devices within a data center. Such an embodiment includes obtaining historical device configuration change and impact data, and processing at least a portion of such historical data using the at least one random forest model to predicts one or more impacted devices in connection with at least one proposed configuration change.

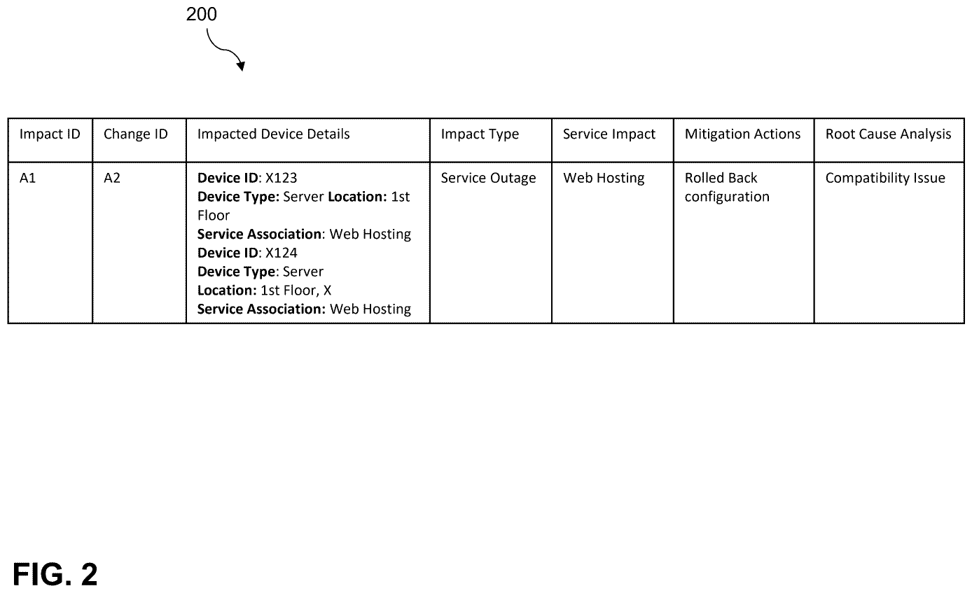

FIG. 2 shows an example dataset of historical impact data in an illustrative embodiment. More particularly, example dataset 200 represents a data structure containing historical data on device configuration and corresponding impacts, wherein such data includes impact identifier (ID), change ID, impacted device details, impact type, service impact, mitigation actions, and root cause analysis information.

After preprocessing at least a portion of the historical data, the at least one random forest model is trained using at least a portion of the preprocessed data, and then the at least one model is evaluated using testing data. When an administrator proposes a configuration change, the at least one random forest model processes data pertaining to the proposed change to predict one or more potential impact on one or more other devices and/or services within the data center. Also, the at least one random forest model can be further trained (e.g., continuously trained) using new data and corresponding predications.

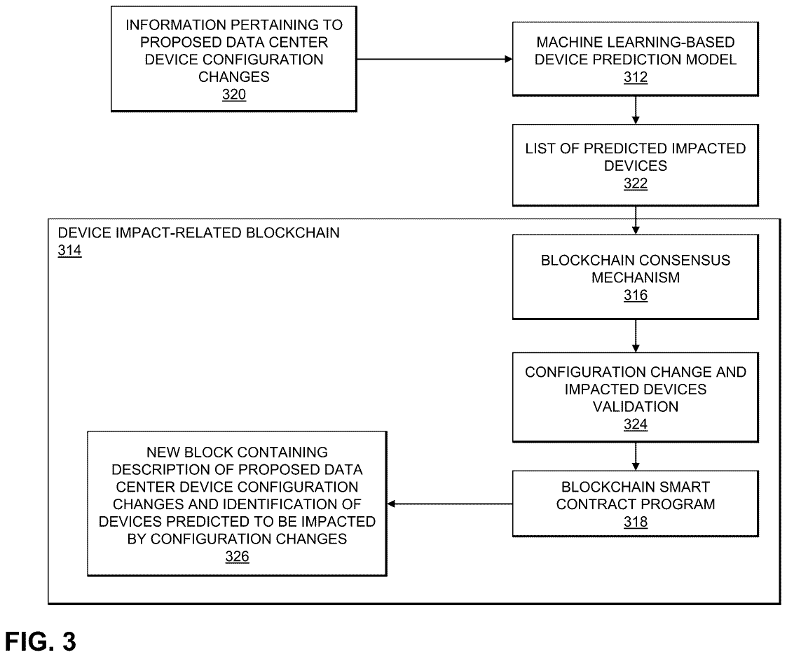

FIG. 3 shows an example workflow in an illustrative embodiment. By way of illustration, FIG. 3 depicts information pertaining to proposed data center device configuration changes 320, which is processed by machine learning-based device prediction model 312 to predict the impact of the proposed configuration changes on one or more other devices within the data center. Based at least in part on this prediction, the machine learning-based device prediction model 312 outputs a list identifying the predicted impacted devices 322. More particularly, the list of predicted impacted devices 322 is provided to blockchain consensus mechanism 316, as part of device impact-related blockchain 314, to be shared with stakeholders (e.g., user devices 102 as depicted in FIG. 1).

In at least one embodiment, the device impact-related blockchain 314 utilizes a multi-signature consensus mechanism to gather consensus from all stakeholders (e.g., global data center administrators, device(s) administrators, local data center administrators, etc.) with respect to the validity of the proposed configuration changes and predicted impacted devices. If consensus is received from all stakeholders, a configuration changes and impacted devices validation 324 is output by the blockchain consensus mechanism 316 and processed by blockchain smart contract program 318 in the device impact-related blockchain 314. Based at least in part on this processing, the blockchain smart contract program 318 automatically adds a new block 326 to the device impact-related blockchain 314, wherein the new block 326 contains a description of the proposed data center device configuration changes and identification of the devices predicted to be impacted by the configuration changes. Alternatively, if consensus is not received by the blockchain smart contract program 318, a new block is not added, and the proposed configuration changes are rejected. Further, at least a portion of the description of the proposed configuration changes and corresponding predicted device impact data can be ingested back into at least one data structure (e.g., device configuration change and impact data structures 107 in the FIG. 1 embodiment) for additional and/or continuous training of the machine learning-based device prediction model 312.

In at least one embodiment, information pertaining to a proposed configuration change and predicted corresponding impact are added to a blockchain transaction. The transaction data can include administrator ID, time stamp, device ID, change details, predicted impact, reason for change, and related services. The transaction is broadcast to all stakeholders for approval of the proposed change. Each stakeholder reviews the proposed change and the model's prediction, and the proposed blockchain uses a multi-signature consensus mechanism to validate the transaction. If the consensus is achieved, the configuration change is automatically applied, and the transaction is added to the blockchain. If consensus is not reached, the change is rejected and the reasons for rejection are recorded.

As such, one or more embodiments include using a machine learning model (e.g., a random forest model) to predict the impact of configuration changes on other devices within a data center based at least in part on historical data. This predictive capability can help in proactive decision-making with respect to configuration changes (e.g., whether to execute the configuration changes, whether to reject and/or cancel the configuration changes, whether to modify the configuration changes, etc.). Also, at least one embodiment includes leveraging blockchain technology to achieve consensus among stakeholders for proposed configuration changes, and use of a blockchain ensures transparency, immutability, and security in the decision-making process. In such an embodiment, use of a multi-signature consensus mechanism ensures that configuration changes are approved by multiple stakeholders before execution. This decentralized approach enhances trust and reduces the risk of biased and/or unauthorized configuration changes.

FIG. 4 is a flow diagram of a process for determining configuration change impacts on data center devices using machine learning techniques in an illustrative embodiment. It is to be understood that this particular process is only an example, and additional or alternative processes can be carried out in other embodiments.

In this embodiment, the process includes steps 400 through 408. These steps are assumed to be performed by the configuration-related device impact prediction system 105 utilizing elements 112, 114, 116, 118 and 120.

Step 400 includes obtaining information pertaining to one or more proposed configuration changes to a first set of one or more devices within at least one data center. In at least one embodiment, obtaining information pertaining to one or more proposed configuration changes includes creating at least one device dependency tree associated with the at least one data center by processing connectivity data across multiple devices within the at least one data center.

Step 402 includes predicting a second set of one or more devices, within the at least one data center, which will be impacted in connection with at least a portion of the one or more proposed configuration changes by processing the obtained information using one or more machine learning techniques. In one or more embodiments, predicting a second set of one or more devices which will be impacted in connection with at least a portion of the one or more proposed configuration changes includes processing the obtained information using at least one random forest model.

Step 404 includes processing the obtained information and the predicted second set of one or more devices which will be impacted using at least one consensus mechanism associated with at least one blockchain. Step 406 includes determining, using one or more smart contracts associated with the at least one blockchain, whether to add at least one new block to the at least one blockchain in response to the processing of the obtained information and the predicted second set of one or more devices which will be impacted using the at least one consensus mechanism. In at least one embodiment, processing the obtained information and the predicted second set of one or more devices which will be impacted includes processing, using the using at least one consensus mechanism, approval of the one or more proposed configuration changes and the predicted second set of one or more devices which will be impacted from each of multiple devices associated with stakeholders of the at least one blockchain. In such an embodiment, determining whether to add at least one new block to the at least one blockchain can include automatically determining to add at least one new block to the at least one blockchain upon processing, using at least a portion of the one or more smart contracts, at least one output from the at least one consensus mechanism related to the approval of the one or more proposed configuration changes and the predicted second set of one or more devices which will be impacted from each of multiple devices associated with stakeholders of the at least one blockchain.

Alternatively, in one or more embodiments, processing the obtained information and the predicted second set of one or more devices which will be impacted includes processing, using the using at least one consensus mechanism, rejection of the one or more proposed configuration changes and the predicted second set of one or more devices which will be impacted from at least one of multiple devices associated with stakeholders of the at least one blockchain. In such an embodiment, determining whether to add at least one new block to the at least one blockchain can include automatically determining not to add at least one new block to the at least one blockchain upon processing, using at least a portion of the one or more smart contracts, at least one output from the at least one consensus mechanism related to the rejection of the one or more proposed configuration changes and the predicted second set of one or more devices which will be impacted from at least one of multiple devices associated with stakeholders of the at least one blockchain.

Step 408 includes performing one or more automated actions based at least in part on the determining of whether to add at least one new block to the at least one blockchain. In at least one embodiment, performing one or more automated actions includes automatically initiating, based at least in part on a determination to add at least one new block to the at least one blockchain, execution of the one or more proposed configuration changes to the first set of one or more devices within the at least one data center. Alternatively, in one or more embodiments, performing one or more automated actions includes automatically cancelling, based at least in part on a determination not to add at least one new block to the at least one blockchain, the one or more proposed configuration changes to the first set of one or more devices within the at least one data center.

Further, in at least one embodiment, performing one or more automated actions can include automatically training at least a portion of the one or more machine learning techniques using feedback related to the determining of whether to add at least one new block to the at least one blockchain.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to predict impacts on data center devices in connection with proposed device configuration changes using machine learning techniques and blockchain technology. These and other embodiments can effectively overcome problems associated with resource-intensive methods that are often reactive in nature and prone to mistakes.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

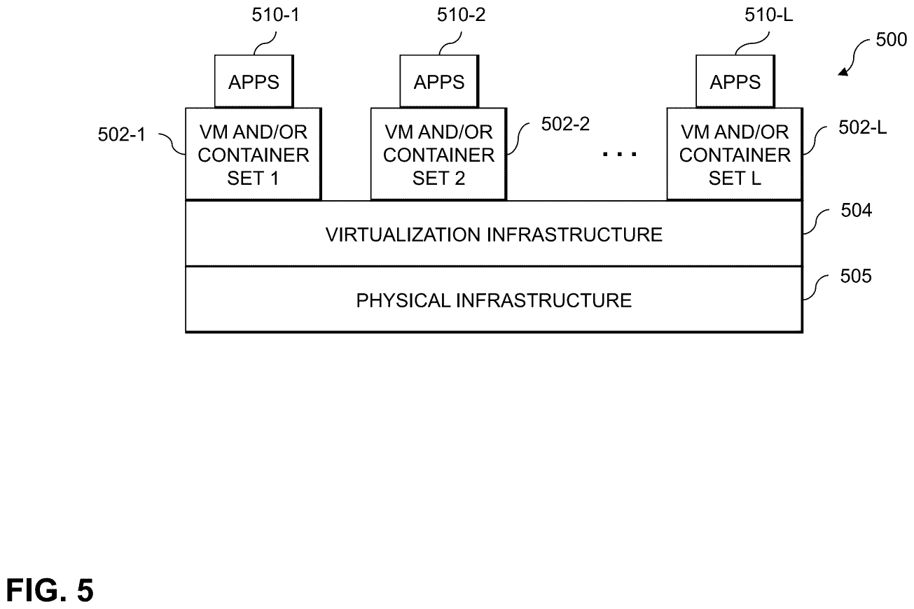

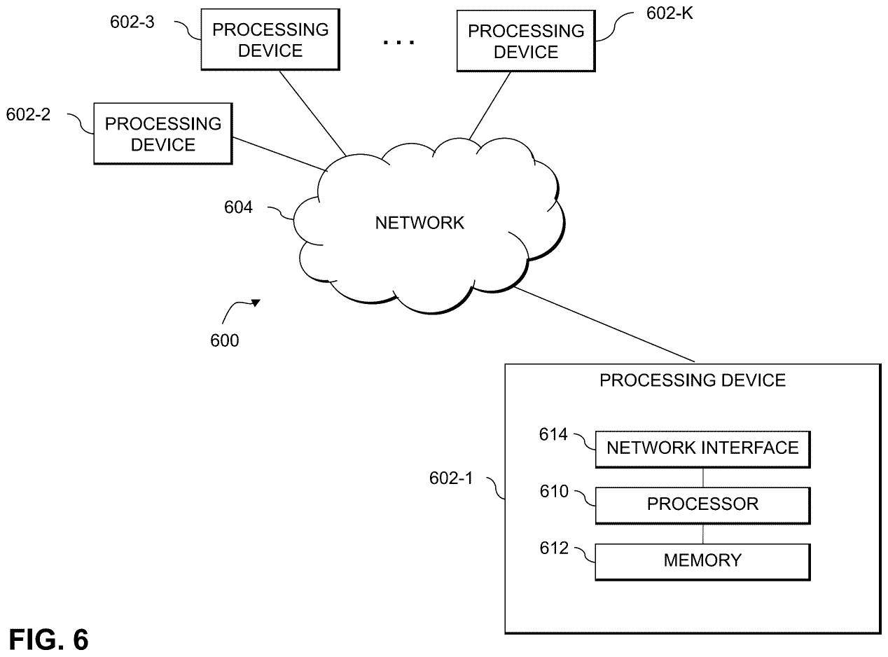

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more information processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory 612 comprises RAM, ROM or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
obtaining information pertaining to one or more proposed configuration changes to a first set of one or more devices within at least one data center;
predicting a second set of one or more devices, within the at least one data center, which will be impacted in connection with at least a portion of the one or more proposed configuration changes by processing the obtained information using one or more machine learning techniques;
processing the obtained information and the predicted second set of one or more devices which will be impacted using at least one consensus mechanism associated with at least one blockchain;
determining, using one or more smart contracts associated with the at least one blockchain, whether to add at least one new block to the at least one blockchain in response to the processing of the obtained information and the predicted second set of one or more devices which will be impacted using the at least one consensus mechanism; and
performing one or more automated actions based at least in part on the determining of whether to add at least one new block to the at least one blockchain;
wherein the method is performed by at least one processing device comprising a processor coupled to a memory.

2. The computer-implemented method of claim 1, wherein performing one or more automated actions comprises automatically initiating, based at least in part on a determination to add at least one new block to the at least one blockchain, execution of the one or more proposed configuration changes to the first set of one or more devices within the at least one data center.

3. The computer-implemented method of claim 1, wherein performing one or more automated actions comprises automatically cancelling, based at least in part on a determination not to add at least one new block to the at least one blockchain, the one or more proposed configuration changes to the first set of one or more devices within the at least one data center.

4. The computer-implemented method of claim 1, wherein predicting a second set of one or more devices which will be impacted in connection with at least a portion of the one or more proposed configuration changes comprises processing the obtained information using at least one random forest model.

5. The computer-implemented method of claim 1, wherein obtaining information pertaining to one or more proposed configuration changes comprises creating at least one device dependency tree associated with the at least one data center by processing connectivity data across multiple devices within the at least one data center.

6. The computer-implemented method of claim 1, wherein processing the obtained information and the predicted second set of one or more devices which will be impacted comprises processing, using the using at least one consensus mechanism, approval of the one or more proposed configuration changes and the predicted second set of one or more devices which will be impacted from each of multiple devices associated with stakeholders of the at least one blockchain.

7. The computer-implemented method of claim 6, wherein determining whether to add at least one new block to the at least one blockchain comprises automatically determining to add at least one new block to the at least one blockchain upon processing, using at least a portion of the one or more smart contracts, at least one output from the at least one consensus mechanism related to the approval of the one or more proposed configuration changes and the predicted second set of one or more devices which will be impacted from each of multiple devices associated with stakeholders of the at least one blockchain.

8. The computer-implemented method of claim 1, wherein processing the obtained information and the predicted second set of one or more devices which will be impacted comprises processing, using the using at least one consensus mechanism, rejection of the one or more proposed configuration changes and the predicted second set of one or more devices which will be impacted from at least one of multiple devices associated with stakeholders of the at least one blockchain.

9. The computer-implemented method of claim 8, wherein determining whether to add at least one new block to the at least one blockchain comprises automatically determining not to add at least one new block to the at least one blockchain upon processing, using at least a portion of the one or more smart contracts, at least one output from the at least one consensus mechanism related to the rejection of the one or more proposed configuration changes and the predicted second set of one or more devices which will be impacted from at least one of multiple devices associated with stakeholders of the at least one blockchain.

10. The computer-implemented method of claim 1, wherein performing one or more automated actions comprises automatically training at least a portion of the one or more machine learning techniques using feedback related to the determining of whether to add at least one new block to the at least one blockchain.

11. A non-transitory processor-readable storage medium having stored therein program code of one or more software programs, wherein the program code when executed by at least one processing device causes the at least one processing device:
to obtain information pertaining to one or more proposed configuration changes to a first set of one or more devices within at least one data center;
to predict a second set of one or more devices, within the at least one data center, which will be impacted in connection with at least a portion of the one or more proposed configuration changes by processing the obtained information using one or more machine learning techniques;
to process the obtained information and the predicted second set of one or more devices which will be impacted using at least one consensus mechanism associated with at least one blockchain;
to determine, using one or more smart contracts associated with the at least one blockchain, whether to add at least one new block to the at least one blockchain in response to the processing of the obtained information and the predicted second set of one or more devices which will be impacted using the at least one consensus mechanism; and
to perform one or more automated actions based at least in part on the determining of whether to add at least one new block to the at least one blockchain.

12. The non-transitory processor-readable storage medium of claim 11, wherein performing one or more automated actions comprises automatically initiating, based at least in part on a determination to add at least one new block to the at least one blockchain, execution of the one or more proposed configuration changes to the first set of one or more devices within the at least one data center.

13. The non-transitory processor-readable storage medium of claim 11, wherein performing one or more automated actions comprises automatically cancelling, based at least in part on a determination not to add at least one new block to the at least one blockchain, the one or more proposed configuration changes to the first set of one or more devices within the at least one data center.

14. The non-transitory processor-readable storage medium of claim 11, wherein predicting a second set of one or more devices which will be impacted in connection with at least a portion of the one or more proposed configuration changes comprises processing the obtained information using at least one random forest model.

15. The non-transitory processor-readable storage medium of claim 11, wherein obtaining information pertaining to one or more proposed configuration changes comprises creating at least one device dependency tree associated with the at least one data center by processing connectivity data across multiple devices within the at least one data center.

16. An apparatus comprising:
at least one processing device comprising a processor coupled to a memory;
the at least one processing device being configured:
to obtain information pertaining to one or more proposed configuration changes to a first set of one or more devices within at least one data center;
to predict a second set of one or more devices, within the at least one data center, which will be impacted in connection with at least a portion of the one or more proposed configuration changes by processing the obtained information using one or more machine learning techniques;
to process the obtained information and the predicted second set of one or more devices which will be impacted using at least one consensus mechanism associated with at least one blockchain;
to determine, using one or more smart contracts associated with the at least one blockchain, whether to add at least one new block to the at least one blockchain in response to the processing of the obtained information and the predicted second set of one or more devices which will be impacted using the at least one consensus mechanism; and
to perform one or more automated actions based at least in part on the determining of whether to add at least one new block to the at least one blockchain.

17. The apparatus of claim 16, wherein performing one or more automated actions comprises automatically initiating, based at least in part on a determination to add at least one new block to the at least one blockchain, execution of the one or more proposed configuration changes to the first set of one or more devices within the at least one data center.

18. The apparatus of claim 16, wherein performing one or more automated actions comprises automatically cancelling, based at least in part on a determination not to add at least one new block to the at least one blockchain, the one or more proposed configuration changes to the first set of one or more devices within the at least one data center.

19. The apparatus of claim 16, wherein predicting a second set of one or more devices which will be impacted in connection with at least a portion of the one or more proposed configuration changes comprises processing the obtained information using at least one random forest model.

20. The apparatus of claim 16, wherein obtaining information pertaining to one or more proposed configuration changes comprises creating at least one device dependency tree associated with the at least one data center by processing connectivity data across multiple devices within the at least one data center.
